(19) United States
(12) Patent Application Publication
(10) Pub. No.: US 2025/0387753 A1
(43) Pub. Date: Dec. 25, 2025

(54) METHOD AND SYSTEM FOR GAS TREATMENT AND PURIFICATION USING MODIFIED ADVANCED OXIDATION TECHNOLOGY

(71) Applicants: Apichet PONGLIKHITTANON, Chonburi (TH); Korada SUPAT, Chonburi (TH)

(72) Inventors: Apichet PONGLIKHITTANON, Chonburi (TH); Korada SUPAT, Chonburi (TH)

(21) Appl. No.: 18/878,589

(22) PCT Filed: Jun. 23, 2023
(86) PCT No.: PCT/TH2023/050013

§ 371 Date: Dec. 23, 2024

Related U.S. Application Data
(60) Provisional application No. 63/354,984, filed on Jun. 23, 2022.

(51) Int. Cl. B01D 53/76; B01D 53/86

(52) U.S. Cl. CPC B01D 53/76; B01D 53/869; B01D 2251/102; B01D 2251/104; B01D 2251/106; B01D 2255/207; B01D 2258/06

(57) ABSTRACT

A method for gas treatment and purification, comprising: generating ozone from a supply of gas comprising an oxygen (O₂) gas in presence of a defined voltage; oxidizing the ozone (O₃), in an oxidization chamber, in presence of light of a pre-defined wavelength and at least one oxidation catalyst to generate a reactive oxygen species (ROS); feeding, in a first reactive space, the generated ROS and water from a water tank to generate the ROS comprising hydroxyl radicals; and supplying, in a second reactive space, the ROS comprising the hydroxyl radicals and a feed gas that comprises one or more contaminants to produce a first treated gas, wherein the first treated gas is produced from the reaction of the feed gas with the ROS comprising the hydroxyl radicals.

### TECHNICAL FIELD

The present disclosure relates generally to the field of gas treatment and purification and, more specifically, to a method for gas treatment and purification and a system for gas treatment and purification using modified advanced oxidation technology.

### BACKGROUND

Global industrialization has led to an increase in environmental pollution. Typically, the environmental pollution is caused by the various contaminants present in gases, such as waste gas obtained from factories, industrial facilities, and the like. Moreover, the said contaminated gases are released into the environment with minimal or no prior treatment thereof, thereby driving climate change and damaging human health.

Generally, advanced oxidation technologies are well-known technologies to remove organic and inorganic substances present in a wastewater. The advanced oxidation technologies are based on the use of hydroxyl radicals for the oxidation of organic and inorganic compounds present in the wastewater. In this regard, the organic and the inorganic compounds are converted into stable compounds, such as water, carbon dioxide, and so forth. Thereby the conversion allows the removal of the contaminants present in the wastewater. Nowadays, the advanced oxidation technologies have begun to be applied in gas treatment and gas purification. However, the conventional advanced oxidation technologies are limited by major factors, such as low efficiency, redundant investment cost, redundant operation cost, and therefore cannot be applied industrially on a large scale. Furthermore, the conventional advanced oxidation technologies are not sufficient to eliminate microorganisms and achieve a high level of disinfection. Additionally, the growing need for effective disinfection techniques in various industries, such as healthcare, food processing, and environmental remediation, necessitates the development of advanced and efficient gas treatment processes.

Therefore, in light of the foregoing discussion, there exists a need to overcome the aforementioned drawbacks associated with gas treatment and purification by conventional advanced oxidation technologies.

### SUMMARY

The present disclosure provides a method for gas treatment and purification and a system for gas treatment and purification using a modified advanced oxidation technology. The present disclosure provides a solution to the existing problem of how to provide an efficient, robust, environmentally friendly, energy-saving, and cost-efficient gas treatment and purification process. An objective of the present disclosure is to provide a solution that overcomes at least partially the problems encountered in the prior art and provides an improved method and system for gas treatment and purification using modified advanced oxidation technology.

One or more objectives of the present disclosure are achieved by the solutions provided in the enclosed independent claims. Advantageous implementations of the present disclosure are further defined in the dependent claims.

In one aspect, the present disclosure provides a method for gas treatment and purification, comprising:
generating ozone from a supply of gas comprising an oxygen (O₂) gas in presence of a defined voltage;
oxidizing the ozone (O₃), in an oxidization chamber, in the presence of light of a pre-defined wavelength and at least one oxidation catalyst to generate a reactive oxygen species (ROS);
feeding, in a first reactive space, the generated ROS and water from a water tank to generate the ROS comprising hydroxyl radicals; and
supplying, in a second reactive space, the ROS comprising hydroxyl radicals and a feed gas that comprises one or more contaminants to produce a first treated gas, wherein the first treated gas is produced from the reaction of the feed gas with the ROS comprising the hydroxyl radicals.

The method employs the modified advanced oxidation technology for removing organic and/or inorganic compounds, contaminants, and odor present in the gas, such as waste gas, through reactions with reactive oxygen species (ROS) for producing the first treated gas. Moreover, the method is used for the generation of reactive oxygen species (ROS) which possess strong disinfection properties. The ROS allows for effective neutralization and destruction of microorganisms present in the gas stream, ensuring a high level of disinfection. Furthermore, the oxidation reactions activated and accelerated by the generated ROS effectively degrade organic components and contaminants in the feed gas, leading to improved gas quality. Additionally, the method can be implemented in various gas treatment systems and adapted to different scales of operation. The method offers flexibility in treating diverse types of gas streams and can be tailored to specific treatment and purification requirements, making it suitable for a range of industrial applications. Additionally, the process promotes environmental sustainability by minimizing the generation of harmful by-products.

In an implementation form, the method further comprises feeding the generated ROS into a compressor and a diffuser prior to the feeding of the generated ROS into the first reactive space, wherein the generated ROS is passed through the compressor and the diffuser in the first reactive space before reacting with the water.

The advantage of feeding the generated ROS through the compressor and the diffuser of the first reactive space is to generate the micro bubbles of the generated ROS to increase surface contact between the generated ROS and the water, ensuring proper distribution and mixing within the first reactive space.

In a further implementation form, the method comprises pre-contacting the generated ROS and the water in a mixer prior to the feeding of the generated ROS and the water in the first reactive space.

The advantage of pre-contacting the generated ROS and the water in a mixer prior to feeding them into the first reactive space is to enhance the interaction between the generated ROS and water, promoting more efficient and effective chemical reactions therebetween.

In a further implementation form, the method further comprises circulating a first portion of the ROS comprising the hydroxyl radicals back to the water tank and supplying a second portion of the ROS comprising the hydroxyl radicals in the second reactive space.

In such an implementation, the circulation of the first portion of the ROS comprising the hydroxyl radicals back to the water tank enables continuous initiation of activity of the ROS comprising the hydroxyl radicals.

In a further implementation form, the first reactive space is a first reactor, preferably a packed-bed reactor, and wherein the generated ROS reacts with the water in the presence of the light of the pre-defined wavelength and at least one oxidation catalyst.

The advantage of using the packed-bed reactor as the first reactive space is to provide a large surface area of the oxidation catalyst and optimal flow distribution for the reaction between the generated ROS and the water, leading to improved efficiency and effectiveness of generation of ROS comprising the hydroxyl radicals.

In a further implementation form, the second reactive space is a second reactor, preferably a packed-bed reactor, and wherein the ROS comprising the hydroxyl radicals reacts with the feed gas in the presence of the light of the pre-defined wavelength and at least one oxidation catalyst.

The advantage of using the packed-bed reactor as the second reactive space is to facilitate efficient interaction between the ROS containing hydroxyl radicals, the feed gas, and the oxidation catalyst, enabling effective chemical reactions and promoting enhanced treatment or purification of the gas.

In a further implementation form, the light of the pre-defined wavelength is an ultraviolet (UV) light.

The advantage of using ultraviolet (UV) light of the pre-defined wavelength is to provide the necessary energy for the desired reactions, promoting efficient and selective activation of the generation of ROS from ozone, generation of the ROS containing hydroxyl radicals from reaction between the generated ROS and water, and treatment and purification of feed gas by the ROS containing hydroxyl radicals leading to improved treatment or purification efficiency.

In a further implementation form, the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, or a lead oxide.

The advantage of selecting the aforementioned transition metal oxides as oxidation catalysts is their capability to facilitate and enhance oxidation reactions effectively, promoting efficient treatment or purification of the gas.

In a further implementation form, the at least one oxidation catalyst is arranged in a packed-bed reactor.

The advantage of arranging the oxidation catalysts in the packed-bed reactor is to optimize their utilization, providing a large surface area for contact between the oxidation catalyst and the reactants and promoting efficient oxidation reactions within the system.

In a further implementation form, the ROS is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, or a singlet oxygen.

The advantage of utilizing the aforementioned ROS is to leverage their specific reactivity and oxidative properties to effectively treat or purify the gas in a targeted and efficient manner.

In a further implementation form, the method further comprises:
feeding the first treated gas obtained from the second reactive space into a third reactive space, wherein the third reactive space is arranged after the second reactive space; and
producing a second treated gas from the third reactive space by causing the first treated gas to react in the presence of the ultraviolet (UV) light and at least one reduction catalyst in the third reactive space.

The advantage of feeding the first treated gas into a third reactive space and causing it to react in the presence of the UV light and a reduction catalyst is to further enhance the treatment or purification process, promoting additional reactions and transformations to produce a second treated gas with improved properties and also terminate the reaction of the ROS comprising the hydroxyl radicals.

In a further implementation form, the third reactive space is a packed-bed reactor.

In a further implementation form, the at least one reduction catalyst is selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide.

In a further implementation form, the method further comprises feeding a hydrogen peroxide into the first reactive space in order to activate and accelerate the generation of the ROS comprising the hydroxyl radicals, wherein the hydrogen peroxide is another ROS.

The advantage of introducing the hydrogen peroxide as another ROS into the first reactive space is to activate and accelerate the generation of the ROS comprising the hydroxyl radicals, facilitating faster reaction kinetics and enhancing the overall treatment or purification process.

In a further implementation form, the method further comprises generating nano bubbles or micro bubbles of a mixture of the generated ROS and the water before feeding the mixture to the first reactive space, wherein the generated nano bubbles or micro bubbles increase surface contact between the water and the reactive oxygen species.

The advantage of generating nano or micro bubbles of a mixture of ROS and water is to increase the surface contact between the reactive oxygen species and water, maximizing the efficiency of their reactions and improving the generation of ROS comprising hydroxyl radicals leading to enhancing the overall treatment or purification process.

In another aspect, the present disclosure provides a system for gas treatment and purification, the system comprising:
a first supply arrangement to provide a supply of gas comprising an oxygen (O₂) gas;
a voltage source, operatively coupled to the supply arrangement, to subject a defined voltage to the supply of gas comprising oxygen (O₂) gas to generate ozone (O₃);
an oxidization chamber configured to oxidize the ozone to generate a reactive oxygen species (ROS) in presence of light of a pre-defined wavelength and at least one oxidation catalyst;
a first reactive space, operatively coupled to the first supply arrangement and the oxidization chamber, is configured to receive the generated ROS and the water to generate the ROS comprising hydroxyl radicals;
a second supply arrangement to provide a supply of a feed gas that comprises one or more contaminants; and
a second reactive space, operatively coupled to the first reactive space, and the second supply arrangement, is configured to receive the generated ROS comprising the hydroxyl radicals and produce a first treated gas from the reaction of the feed gas with the ROS comprising the hydroxyl radicals.

The system achieves all the advantages and technical effects of the method of the present disclosure.

In a further implementation form, the second reactive space further comprises a sprayer. The sprayer comprises a nozzle configured to pass the generated ROS comprising the hydroxyl radicals into the second reactive space in order to increase surface contact between the generated ROS comprising the hydroxyl radicals and the feed gas.

It is to be appreciated that all the aforementioned implementation forms can be combined. It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of a method for gas treatment and purification, in accordance with an embodiment of the present disclosure;

FIG. 2 is a schematic diagram of a system for gas treatment and purification, in accordance with an embodiment of the present disclosure;

FIG. 3 is a graphical representation of measured values of concentration of chemical compounds present in a feed gas and a first treated gas, in accordance with an embodiment of the present disclosure; and

FIG. 4 is a graphical representation of measured values of concentration of volatile organic compounds (VOCs) present in a feed gas and a first treated gas, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

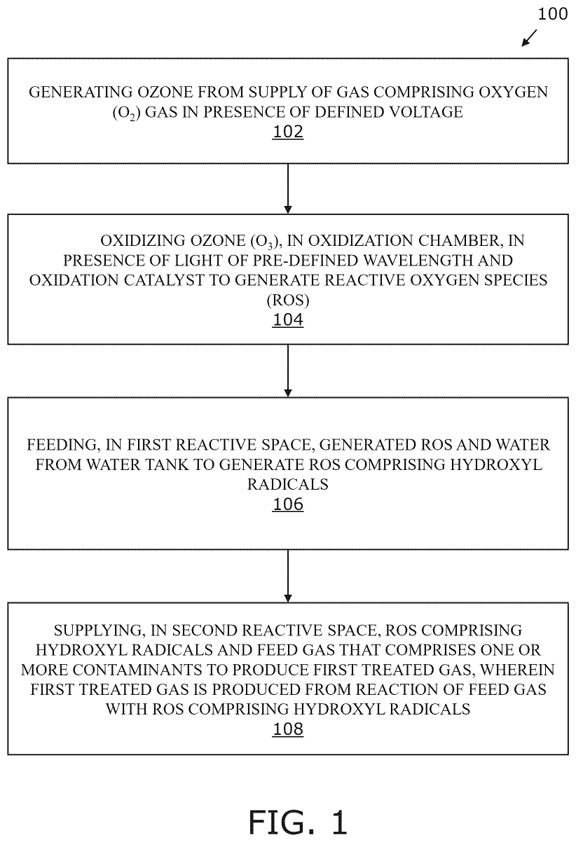

FIG. 1 is a flowchart of a method for gas treatment and purification, in accordance with an embodiment of the present disclosure. With reference to FIG. 1, there is shown a flowchart of a method 100 for gas treatment and purification. The method includes steps 102 to 108.

There is provided the method 100 for gas treatment and purification using a modified advanced oxidation technology. The modified advanced oxidation technology refers to a set of chemical treatment processes that involve the generation of highly reactive oxygen species to degrade and remove organic and/or inorganic compounds present in the fluids (e.g., waste gas, wastewater, and the like) through reactions with a reactive oxygen species (ROS) for treatment and purification of the fluids. Moreover, the modified advanced oxidation technology includes generation of ROS that can attack any organic materials without discrimination. The method 100 is used to treat and/or purify the gas. In an example, the gas is a contaminated gas, a waste gas obtained from a factory or an industrial facility before release thereof into an environment. The gas treatment refers to processes and means by which contaminants in gases from any sources are converted into less harmful substances, such as the conversion of gas emissions from waste disposal into less harmful substances. For example, converting hydrogen sulfide (H₂S) and thioformaldehyde (CH₂S) in the waste gas to carbon dioxide (CO₂), hydrogen (H₂), and sulphur (S) in a solid form. For example, removing or converting particulate matter (PM 2.5) from the atmosphere in a closed space, such as a building, and the like. In an implementation, the method 100 enables disinfection of the gas. The disinfection refers to processes and means of destroying pathogenic microorganisms in order to interrupt the infection transmission mechanism by disinfecting various objects, for example, destroying pathogenic microorganisms on the surface of fruits. In an implementation, the method 100 enables the sanitization of the gas. The sanitization refers to processes and means of making a subject sanitary (i.e., free of germs), for example, sanitization of an operating room.

At step 102, the method 100 includes generating ozone from a supply of gas including an oxygen (O₂) gas in presence of a defined voltage. In an implementation, the supply of gas is provided through a supply arrangement that includes the oxygen gas. Moreover, the supply arrangement may be a gas cylinder, a gas well, or a network of pipelines to provide a continuous supply of the gas. The supply arrangement enables an efficient and improved control over a pressure of the gas, thereby allowing a safe and economical supply of the gases. Furthermore, a voltage source is operatively coupled to the supply arrangement in order to provide the defined voltage to the supply of gas. In an example, the defined voltage is in a range from 0.5 kilovolts (kV) to 30 kilovolts (kV) to ensure the efficient production of ozone. In an implementation, the method 100 may involve using an ozone generator to apply the defined voltage to the oxygen gas, causing the oxygen gas to undergo a chemical reaction and form ozone (O₃) molecules.

At step 104, the method 100 includes oxidizing the ozone (O₃), in an oxidization chamber, in presence of light of a pre-defined wavelength and at least one oxidation catalyst to generate the reactive oxygen species (ROS). In this regard, the oxidization chamber includes a light source that emits light of the pre-defined wavelength. In an implementation, the wavelength is pre-defined based on the desired reaction conditions and the characteristics of the at least one oxidation catalyst that is used for oxidizing the ozone. It will be appreciated that the pre-defined wavelength is chosen to optimize the energy absorption and activation of the ozone molecules, promoting the conversion of the ozone molecules into the reactive oxygen species. In an example, the oxidization chamber may be a hermetically sealed chamber. Moreover, the oxidization chamber includes an inlet configured to receive the supply of gas including the ozone into the oxidization chamber.

In accordance with an embodiment, the light of the pre-defined wavelength is an ultraviolet (UV) light. In an implementation, the pre-defined wavelength of the ultraviolet (UV) light may range from 100 nm to 400 nm. In addition, the at least one oxidation catalyst refers to a catalyst that causes oxidation reactions. It will be appreciated that the at least one oxidation catalyst is an active site to accelerate the reaction by decreasing the activation energy of each reaction.

Optionally, a catalyst support is the part where the at least one oxidation catalyst is attached (affixed) for increasing the surface contact of the at least one oxidation catalyst. In this regard, the at least one oxidation catalyst enables the transfer of oxygen atoms, hydrogen atoms, or electrons, during the reaction.

At step 106, the method 100 comprises feeding, in a first reactive space, the generated ROS and water from a water tank to generate the ROS comprising hydroxyl radicals. The first reactive space as used herein refers to a process vessel that is used to carry out a chemical reaction under appropriate process variables. In accordance with an embodiment, the first reactive space is a first reactor, and the generated ROS reacts with the water in the presence of the light of the pre-defined wavelength and at least one oxidation catalyst. In an implementation, the first reactor is used as the first reactive space to facilitate a controlled environment for the reaction to occur efficiently. In addition, the light energy of the pre-defined wavelength promotes the activation of the generated ROS, accelerating the oxidation reactions and improving the kinetics of the process, such as to generate the ROS comprising hydroxyl radicals. In other words, the ROS comprising hydroxyl radicals is generated from the reaction of the generated ROS with the water in presence of the ultraviolet (UV) light and in presence of the at least one oxidation catalyst. In another implementation, the first reactive space, the light of the pre-defined wavelength, and at least one oxidation catalyst work in conjunction with each other to allow for the customization of the method 100 to address specific pollutant removal requirements, such as to generate the ROS comprising hydroxyl radicals.

In accordance with an embodiment, the method 100 comprises feeding the generated ROS into a compressor and a diffuser prior to the feeding of the generated ROS into the first reactive space, wherein the generated ROS is passed through the compressor and the diffuser in the first reactive space before reacting with the water. The compressor is a mechanical device that increases the pressure of the generated ROS by reducing its volume, in order to be able to push the generated ROS flow through diffuser which have small openings on its surface in order to create micro bubbles of the generated ROS in the water.

In accordance with an embodiment, the method 100 comprises pre-contacting the generated ROS and the water in a mixer prior to the feeding of the generated ROS and the water in the first reactive space. The pre-contacting of the generated ROS and the water in the mixer increases the efficiency of the reaction between the generated ROS and the water. The generated ROS are fed into the mixer to mix with the water before feeding thereof into the first reactive space to generate the ROS comprising hydroxyl radicals. It will be appreciated that the pre-contacting improves the efficiency of the gas treatment and purification in some cases. For example, the pre-contacting may improve the efficiency of gas treatment and purification when the at least one oxidation catalyst is not applied in the first reactive space.

At step 108, the method 100 comprises supplying, in a second reactive space, the ROS comprising the hydroxyl radicals and a feed gas that includes one or more contaminants to produce a first treated gas, such as the first treated gas is produced from the reaction of the feed gas with the ROS comprising the hydroxyl radicals.

In accordance with an embodiment, in the second reactive space, the ROS comprising the hydroxyl radicals flow through a high-pressure sprayer with atomizing liquid nozzle or vaporization in order to increase surface contact between the ROS comprising the hydroxyl radicals and the feed gas. The reaction of the feed gas with the ROS comprising the hydroxyl radicals produces the first treated gas.

The second reactive space as used herein refers to a process vessel that is used to carry out a chemical reaction under appropriate process variables. The second reactive space is designed to facilitate the reaction between the ROS comprising the hydroxyl radicals and the pollutants or contaminants present in the feed gas, such as the feed gas is fed in the second reactive space. In an example, the feed gas includes compounds, such as volatile organic compounds (VOCs), hydrocarbon compounds, sulfur compounds, and so forth, aimed for treatment and/or purification. In an implementation, the feed gas is the gas as obtained from the unit operation or includes, for example, ammonia gas (NH₃), Hydrogen Sulfide (H₂S), mercaptan (CH₄S), and VOCs (total volatile organic compound). In an implementation, the concentration of the NH₂ is higher than 99.9 ppm in the feed gas. In another implementation, the concentration of the H₂S is higher than 99.9 ppm in the feed gas. In yet another implementation, the concentration of the CHS is higher than 9.9 ppm in the feed gas. In another implementation, the concentration of the VOCs is higher than 999.0 ppm in the feed gas. Furthermore, the ROS comprising the hydroxyl radicals, obtained from the first reactive space, is fed into the second reactive space. In an implementation, the ROS comprising the hydroxyl radicals is fed into the second reactive space together with the feed gas (e.g., contaminated air in the room), which is sucked from a closed environment (e.g., a room) in order to achieve an efficient and good circulation of the clean air in the closed environment. In an implementation, the ROS comprising the hydroxyl radicals is fed into the second reactive space together with the feed gas, such as contaminated air from outside of the closed system, which is sucked from the environment in order to obtain clean air for uptaking into the closed system.

In this regard, the second reactive space allows the reaction between the feed gas and the generated ROS comprising the hydroxyl radicals, thus facilitating the removal or reduction of pollutants, contaminants, or undesirable components present in the feed gas. As a result, the first treated gas obtained from the reaction is cleaner, lower or no from harmful substances, and more suitable for various applications. The efficient reaction mechanism reduces the residence time required for effective treatment, leading to improved process throughput and reduced energy consumption.

In accordance with an embodiment, the second reactive space is a second reactor, and the ROS comprising the hydroxyl radicals reacts with the feed gas in the presence of the light of the pre-defined wavelength and at least one oxidation catalyst. Further, due to an efficient operation thereof, the second reactor is used as the second reactive space, thereby allowing the reaction to occur under optimum process conditions.

In accordance with an embodiment, the method 100 comprises circulating a first portion of the ROS including the hydroxyl radicals back to the water tank and supplying a second portion of the ROS including the hydroxyl radicals in the second reactive space. In this regard, the circulated first portion of the ROS including the hydroxyl radicals is fed into the water tank for continuous activation of the activity of the ROS including the hydroxyl radicals that includes the hydroxyl radicals. In an implementation, the second portion of the ROS comprising the hydroxyl radicals with a high concentration of hydroxyl radicals is pumped by using a high-pressure pump to the second reactive space.

In accordance with an embodiment, the first reactive space and the second reactive space are packed-bed reactors. In this regard, when the first reactive space is implemented as the packed-bed reactor then the surface contact between the generated ROS and the water from the water tank increases, thereby improving the reaction therebetween. Moreover, when the second reactive space is implemented as the packed-bed reactor then the surface contact between the ROS comprising the hydroxyl radicals and the feed gas that includes the one or more contaminants increases, thereby improving the reaction therebetween in the presence of the ultraviolet (UV) light and the at least one oxidation catalyst.

In accordance with an embodiment, the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, or a lead oxide. The technical effect of including the at least one or more transition metal oxides as the at least one oxidation catalyst is to enhance the efficiency of the oxidation process within an oxidization chamber, the first reactive space and the second reactive space. Typically, the at least one or more transition metal oxides exhibit high catalytic activity, promoting the conversion of ozone into the ROS, reaction between the generated ROS and water to produce the ROS comprising the hydroxyl radicals as well as reaction between comprising the hydroxyl radicals and feed gas for gas treatment and purification. The at least one or more transition metal oxides provide active site for the adsorption and activation of ozone molecules, leading to the decomposition of the ozone molecules and the generation of the reactive oxygen species. In accordance with an embodiment, the at least one oxidation catalyst is arranged in a packed-bed reactor. In such implementation, the method 100 employs the at least one oxidation catalyst in the packed-bed reactor to improve the surface contact between the catalyst and ozone in the oxidization chamber, among the catalyst, the generated reactive oxygen species and water in the first reactive space, and among the catalyst, the feed gas and the ROS comprising the hydroxyl radicals in the second reactive space, thereby improving the reaction therebetween.

In accordance with an embodiment, the ROS is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, or a singlet oxygen. Typically, the reactive oxygen species operate via one-electron oxidation (e.g., radical ROS species) or two-electron oxidation (e.g., non-radical ROS species).

In an implementation, the ROS are mainly oxidizing agents that can oxidize other chemical elements by accepting the electrons therefrom. It will be appreciated that the ROS support disinfecting the feed gas by neutralizing or destroying microorganisms, such as bacteria, viruses, and fungi present therein. In an implementation, the ROS may act as a reducing agent as well depending upon the oxidation state thereof. Furthermore, the superoxide anion (O₂^{·}₋) is produced by the one-electron reduction of molecular oxygen. Moreover, in aqueous media, protonation of superoxide can form the uncharged hydroperoxyl radical (HOO·). In addition, the superoxide anion is used to provide a readily available source of oxygen and is an improved reducing agent as compared to an oxidizing agent. The hydrogen peroxide is a closed-shell molecule resulting from the one-electron reduction of O₂^{·}−. The singlet oxygen refers to a gaseous inorganic chemical with the formula O═O (¹O₂). The singlet oxygen is a strong oxidant and is far more reactive toward organic compounds. Furthermore, the peroxy radicals possess a low oxidizing ability as compared to hydroxyl radical but include a high diffusibility of the reactant molecules in the catalytic reaction. Additionally, the alkoxyl radicals have intermediate reactivity between the hydroxyl radical and the peroxy radical. Typically, superoxide (O₂^{·}−), hydroxyl (OH^{·}), peroxyl (RO₂^{·}), alkoxyl (RO^{·}), hydroperoxyl (HO₂^{·}), nitric oxide (NO^{·}) and nitrogen dioxide (NO₂^{·}) are the radical species. Typically, hydrogen peroxide (H₂O₂), hypochlorous acid (HOCl—), ozone (O₃), singlet oxygen (¹O₂), peroxynitrite (ONOO—), alkyl peroxynitrites (ROONO), dinitrogen trioxide (N₂O₃), dinitrogen tetroxide (N₂O₄), nitrous acid (HNO₂), nitronium anion (NO₂₊), nitoxyl anion (NO⁻), nitrosyl cation (NO⁺), and nitryl chloride (NO₂Cl) are the non-radical species.

In accordance with an embodiment, the method 100 further comprises feeding the first treated gas obtained from the second reactive space into a third reactive space, such as the third reactive space is arranged after the second reactive space, and producing a second treated gas from the third reactive space by causing the first treated gas to react in presence of the ultraviolet (UV) light and at least one reduction catalyst in the third reactive space. In an implementation, the third reactive space is a reduction reactor. The reduction catalysts refer to catalysts that cause reduction reactions. In this regard, the reduction catalysts reduce hazardous compounds, for example, oxides of nitrogen (NOx) to less harmful products like nitrogen (N₂). Moreover, the reduction catalysts are used to terminate the reactive of the ROS comprising the hydroxyl radicals.

In an implementation, the second reactive space also outputs a residual liquid that includes dissolvable components, such as nitrate (NO3), sulfur trioxide (SO3) as well as oxide of metal contaminants. Hence, the second treated gas contains a low concentration of harmful chemical compounds, such as nitrogen (N), sulfur (S), halogen-containing components, virus, bacteria, and so forth.

In accordance with an embodiment, the method 100 further comprises feeding a hydrogen peroxide into the first reactive space in order to activate and accelerate the generation of the ROS, such as the hydrogen peroxide is another ROS. The hydrogen peroxide is a closed-shell molecule resulting from the one-electron reduction of O₂^{·}−. In such implementation, the hydrogen peroxide (H2O2) is used to activate and accelerate the reaction between the generated ROS and the water obtained from the water tank. Moreover, the hydrogen peroxide is used to increase the efficiency of the reaction between the generated ROS and the water. In an example, the hydrogen peroxide is acted both as an oxidizing agent as well as a reducing agent. Moreover, the reduction of the hydrogen peroxide output the hydroxyl radical (OH^{·}) that undergoes reduction to output the water (or hydroxide OH— ions). Optionally, the hydrogen peroxide enables the production of free radicals when the at least one oxidation catalyst is fed in the first reactive space. In an implementation, the H₂O₂ is fed to activate and accelerate the efficiency of the reaction.

In accordance with an embodiment, the method 100 further comprises generating nano bubbles or micro bubbles of a mixture of the generated ROS and the water before feeding the mixture to the first reactive space, such as the generated nano bubbles or micro bubbles increase surface contact between the water and the reactive oxygen species. In this regard, the mixing components, such as the generated ROS and the water will pass through a pump, which will generate the nano bubbles or the micro bubbles to increase surface contact between the water and the generated ROS.

The steps 102 to 108 are only illustrative, and other alternatives can also be provided where one or more steps are added, one or more steps are removed, or one or more steps are provided in a different sequence without departing from the scope of the claims herein.

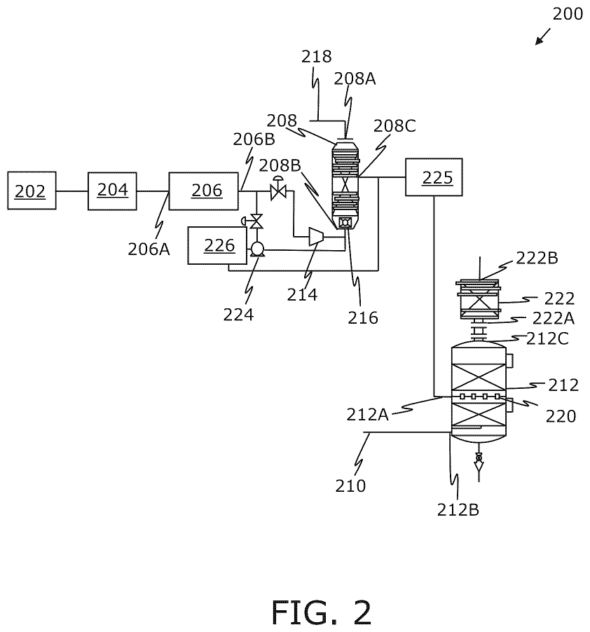

FIG. 2 is a schematic diagram of a system for gas treatment and purification, in accordance with an embodiment of the present disclosure. With reference to FIG. 2, there is shown a system 200 that comprises a first supply arrangement 202, a voltage source 204, an oxidization chamber 206, a first reactive space 208, a second supply arrangement 210, and a second reactive space 212. There is further shown, a compressor 214, a diffuser 216, a supply 218 of a hydrogen peroxide, a sprayer 220, a third reactive space 222, at least one pump 224, at least one pump 225 and a water tank 226.

There is provided the system 200 for gas treatment and purification using a modified advanced oxidation technology. The modified advanced oxidation technology refers to a set of chemical treatment processes that involve the generation of highly reactive oxidizing species to degrade and remove organic and/or inorganic compounds present in the fluids (e.g., waste gas, wastewater, and the like) through reactions with a reactive oxygen species (ROS) for treatment and purification of the fluids. Moreover, the modified advanced oxidation technology includes the generation of ROS that can attack any organic material without discrimination. The system 200 is used to treat and/or purify the gas. In an example, the gas is a contaminated gas, a waste gas obtained from a factory or an industrial facility before release thereof into an environment. The gas treatment refers to processes and means by which contaminants in gases from any sources are converted into less harmful substances, such as the conversion of gas emissions from waste disposal into less harmful substances. For example, converting hydrogen sulfide (H₂S) and thioformaldehyde (CH₂S) in the waste gas to carbon dioxide (CO₂), hydrogen (H₂), and sulphur (S) in a solid form. For example, removing or converting particulate matter (PM 2.5) from the atmosphere in a closed space, such as a building, and the like. In an implementation, the system 200 enables disinfection of the gas. The disinfection refers to processes and means of destroying pathogenic microorganisms in order to interrupt the infection transmission mechanism by disinfecting various objects, for example, destroying pathogenic microorganisms on the surface of fruits. In an implementation, the system 200 enables the sanitization of the gas. The sanitization refers to processes and means of making a subject sanitary (i.e., free of germs), for example, sanitization of an operating room.

The first supply arrangement 202 may be a gas cylinder, a gas well, or a network of pipelines to provide a continuous supply of the gas. The first supply arrangement 202 is configured to provide a supply of gas including oxygen (O₂) gas. The first supply arrangement 202 enables an efficient and improved control in the pressure of the gas, thereby allowing a safe and economical supply of the gas in the system 200. Furthermore, a voltage source 204 is operatively coupled to the first supply arrangement 202 in order to provide the defined voltage to the supply of gas. In an example, the defined voltage is in a range from 0.5 kilovolts (kV) to 30 kilovolts (kV) to ensure the efficient production of ozone. In an implementation, the system 200 may involve using an ozone generator to apply the defined voltage to the oxygen gas, causing the oxygen gas to undergo a chemical reaction and form ozone (O₃) molecules. In other words, the voltage source 204 is communicably coupled with an inlet that is configured to supply gas including oxygen (O₂) from the first supply arrangement 202 thereof at one end and another inlet 206A that is configured to supply the ozone and/or gases including ozone into the oxidization chamber 206 at another end. In an example, the defined voltage is in a range from 0.5 kilovolts (kV) to 30 kilovolts (kV). In an operation, the defined voltage is used for converting the gas including oxygen (O₂) into ozone (O₃).

The oxidization chamber 206 is a hermetically sealed chamber. In this regard, the oxidization chamber 206 includes an inlet 206A that is configured to receive a supply of gas including ozone (O₃) into the oxidization chamber 206 and an outlet 206B that is configured to output a generated ROS. Moreover, the oxidization chamber 206 includes a light source configured to output the ultraviolet (UV) light of the pre-defined wavelength. In accordance with an embodiment, the light source is an ultraviolet lamp. In an implementation, the ultraviolet lamp may be placed in proximity to the inlet 206A that supplies gases including ozone (O₃) into the oxidization chamber 206. In accordance with an embodiment, the pre-defined wavelength of the ultraviolet (UV) light ranges from 100 nm to 400 nm. It will be appreciated that the pre-defined wavelength is chosen to optimize the energy absorption and activation of the ozone molecules, promoting the conversion of the ozone molecules into the reactive oxygen species.

The oxidization chamber 206 includes the at least one oxidation catalyst that refers to a catalyst, which causes oxidation reactions. In this regard, the oxidation catalyst enables the transfer of oxygen atoms, hydrogen atoms, or electrons, during the reaction. Additionally, the use of oxidation catalysts enhances the rate of oxidation (reduces the activation-energy barrier) by adsorbing the oxygen on the corresponding surface. In an implementation, the combination of the pre-defined wavelength light and the oxidation catalyst creates an environment that promotes the efficient conversion of ozone into the reactive oxygen species.

In accordance with an embodiment, the light of the pre-defined wavelength is an ultraviolet (UV) light. In an implementation, the pre-defined wavelength of the ultraviolet (UV) light may range from 100 nm to 400 nm. In addition, the at least one oxidation catalyst refers to a catalyst that causes oxidation reactions. It will be appreciated that the at least one oxidation catalyst is an active site to accelerate the reaction by decreasing the activation energy of each reaction. Optionally, a catalyst support is the part where the at least one oxidation catalyst is attached (affixed) for increasing the surface contact of the at least one oxidation catalyst. In this regard, the at least one oxidation catalyst enables the transfer of oxygen atoms, or electrons, during the reaction.

In an implementation, the generated ROS are mainly oxidizing agents that can oxidize other chemical elements by accepting the electrons therefrom. It will be appreciated that the generated ROS support disinfecting a gas by neutralizing or destroying microorganisms, such as bacteria, viruses, and fungi present therein. In an implementation, the generated ROS may act as a reducing agent as well depending upon the oxidation state thereof. Furthermore, the superoxide anion (O₂^{·-}) is produced by the one-electron reduction of molecular oxygen. Moreover, in aqueous media, protonation of superoxide can form the uncharged hydroperoxyl radical (HOO·). In addition, the superoxide anion is used to provide a readily available source of oxygen and is an improved reducing agent as compared to an oxidizing agent. The hydrogen peroxide is a closed-shell molecule resulting from the one-electron reduction of O₂^{·}−. The singlet oxygen refers to a gaseous inorganic chemical with the formula O═O (¹O₂). The singlet oxygen is a strong oxidant and is far more reactive toward organic compounds. Furthermore, the peroxy radicals possess a low oxidizing ability as compared to hydroxyl radicals but include a high diffusibility of the reactant molecules in the catalytic reaction. Additionally, the alkoxyl radicals have intermediate reactivity between the hydroxyl radical and the peroxy radical. Typically, superoxide (O₂^{·}−), hydroxyl (OH^{·}), peroxyl (RO₂^{·}), alkoxyl (RO^{·}), hydroperoxyl (HO₂^{·}), nitric oxide (NO^{·}) and nitrogen dioxide (NO₂^{·}) are the radical species. Typically, hydrogen peroxide (H₂O₂), hypochlorous acid (HOCl—), ozone (O₃), singlet oxygen (¹O₂), peroxynitrite (ONOO—), alkyl peroxynitrites (ROONO), dinitrogen trioxide (N₂O₃), dinitrogen tetroxide (N₂O₄), nitrous acid (HNO₂), nitronium anion (NO₂₊), nitroxyl anion (NO⁻), nitrosyl cation (NO⁺), and nitryl chloride (NO₂Cl) are the non-radical species.

The first reactive space 208 as used herein refers to a process vessel that is used to carry out a chemical reaction under appropriate process variables. In accordance with an embodiment, the first reactive space 208 is a first reactor, and the generated ROS reacts with the water in presence of the light of the pre-defined wavelength and at least one oxidation catalyst. In an implementation, the first reactor is used as the first reactive space 208 to facilitate a controlled environment for the reaction to occur efficiently. In addition, the light energy of the pre-defined wavelength promotes the activation of the generated ROS, accelerating the oxidation reactions and improving the kinetics of the process, such as to generate the ROS including hydroxyl radicals. In other words, the ROS including hydroxyl radicals is generated from the reaction of the generated ROS with the water in presence of the ultraviolet (UV) light and in presence of the at least one oxidation catalyst. In another implementation, the first reactive space 208, the light of the pre-defined wavelength, and at least one oxidation catalyst work in conjunction with each other to allow for the customization of the system 200 to address specific pollutant removal requirements, such as to generate the ROS including hydroxyl radicals. In accordance with an embodiment, the first reactive space 208 is a packed-bed reactor. In such implementation, the packed-bed reactors provide a large surface area for the interaction between catalyst and reactants i.e., the water and the reactive oxygen species. Moreover, the packing material arranged in the packed-bed reactor creates a high contact efficiency, ensuring intimate mixing and prolonged interaction between the reactants. Thus the packed-bed reactors lead to improved reaction kinetics.

The second supply arrangement 210 is used to provide a supply of a feed gas that comprises one or more contaminants. Moreover, the second reactive space 212 as used herein refers to a process vessel that is used to carry out a chemical reaction under appropriate process variables. The second reactive space 212 is designed to facilitate the reaction between the ROS comprising the hydroxyl radicals and the pollutants or contaminants present in the feed gas, such as the feed gas is fed in the second reactive space 212. In an example, the feed gas includes compounds, such as volatile organic compounds (VOC), hydrocarbon compounds, sulfur compounds, and so forth, aimed for treatment and/or purification. In an implementation, the feed gas is the gas as obtained from the unit operation or includes, for example, ammonia gas (NH₃), Hydrogen Sulfide (H₂S), mercaptan (CH₄S), and VOCs (total volatile organic compound). In an implementation, the concentration of the NH₃ is higher than 99.9 ppm in the feed gas. In another implementation, the concentration of the H₂S is higher than 99.9 ppm in the feed gas. In yet another implementation, the concentration of the CH₄S is higher than 9.9 ppm in the feed gas. In another implementation, the concentration of the VOCs is higher than 999.0 ppm in the feed gas. Furthermore, the ROS comprising the hydroxyl radicals, obtained from the first reactive space 208, is fed into the second reactive space 212. In an implementation, the ROS comprising the hydroxyl radicals is fed into the second reactive space 212 together with the feed gas (e.g., contaminated air in the room), which is sucked from a closed environment (e.g., a room) in order to achieve an efficient and good circulation of the clean air in the closed environment. In an implementation, the ROS comprising the hydroxyl radicals is fed into the second reactive space 212 together with the feed gas, such as contaminated air from outside of the closed system, which is sucked from the environment in order to obtain clean air for uptaking into the closed system.

In this regard, the second reactive space 212 allows the reaction between the feed gas and the generated ROS comprising the hydroxyl radicals, thus facilitating the removal or reduction of pollutants, contaminants, or undesirable components present in the feed gas. As a result, the first treated gas obtained from the reaction is cleaner, lower or no from harmful substances, and more suitable for various applications. The efficient reaction mechanism reduces the residence time required for effective treatment, leading to improved process throughput and reduced energy consumption.

In accordance with an embodiment, the system 200 further comprises a compressor 214 and a diffuser 216 wherein the compressor 214 is operatively coupled to the diffuser 216 and the oxidization chamber 206 and the diffuser 216 is in the first reactive space 208. The compressor 214 is a mechanical device that increases the pressure of the generated ROS by reducing its volume, in order to be able to push the generated ROS flow through diffuser 216 which have small openings on its surface in order to create micro bubbles of the generated ROS.

In accordance with an embodiment, the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, and a lead oxide. In accordance with an embodiment, the at least one oxidation catalyst is arranged in a packed-bed reactor. In such implementation, the system 200 employs the at least one oxidation catalyst in the packed-bed reactor to improve the surface contact among the catalyst and reactants such as the feed gas and the generated ROS comprising hydroxyl radicals, thereby improving the reaction therebetween.

In accordance with an embodiment, the at least one oxidation catalyst is arranged in a packed-bed reactor. In such implementation, the system 200 employs the at least one oxidation catalyst in the packed-bed reactor to improve the surface contact among the catalyst and reactants such as the feed gas and the generated ROS comprising hydroxyl radicals, thereby improving the reaction therebetween. In accordance with an embodiment, the ROS is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, or a singlet oxygen.

In accordance with an embodiment, the first reactive space is a first reactor, the first reactive space comprises a light source configured to supply the ultraviolet (UV) light with a uniform distribution of light intensity in the first reactive space, a catalyst in a packed-bed reactor including the at least one oxidation catalyst of one or more transition metal oxides, a plurality of inlets configured to receive the hydrogen peroxide (H₂O₂) and the generated ROS and the water into the first reactive space and an outlet to output the ROS comprising hydroxyl radicals.

In accordance with an embodiment, the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, and a lead oxide. The technical effect of including the at least one or more transition metal oxides as the at least one oxidation catalyst is to enhance the efficiency of the oxidation process within an oxidization chamber, the first reactive space, and the second reactive space. Typically, the at least one or more transition metal oxides exhibit high catalytic activity, such as promoting the conversion of ozone into the ROS. In accordance with an embodiment, the system further comprises a supply 218 of a hydrogen peroxide into the first reactive space 208 to activate and accelerate the generation of the ROS, wherein the hydrogen peroxide is another ROS. The hydrogen peroxide is a closed-shell molecule resulting from the one-electron reduction of O₂^{·}−. In such implementation, the hydrogen peroxide (H₂O₂) is used to activate and accelerate the reaction between the generated ROS and the water obtained from the water tank 226. Moreover, the hydrogen peroxide is used to increase the efficiency of the reaction between the generated ROS and the water. In an example, the hydrogen peroxide is acts both as an oxidizing agent as well as a reducing agent. The hydrogen peroxide is a closed-shell molecule resulting from the one-electron reduction of O₂⁻. Moreover, the reduction of the hydrogen peroxide output the hydroxyl radical (OH^{·}) that undergoes reduction to output the water (or hydroxide OH— ions). Optionally, the hydrogen peroxide enables the production of free radicals when the at least one oxidation catalyst is fed in the first reactive space 208. In an implementation, the H₂O₂ is fed to activate and accelerate the efficiency of the reaction.

In accordance with an embodiment, the second reactive space 212 is a second reactor, the second reactive space 212 comprises a plurality of inlets 212A and 212B configured to receive the generated ROS comprising hydroxyl radicals and the feed gas therein, the sprayer 220 comprising a nozzle configured to pass the ROS comprising hydroxyl radicals therethrough, and an outlet 212C to output the first treated gas. The second reactive space 212 is designed to facilitate further reactions between the generated reactive oxygen species (ROS), specifically hydroxyl radicals, and the feed gas. The second reactive space 212 consists of multiple inlets, labeled as inlets 212A and 212B, which are configured to receive the ROS containing hydroxyl radicals and the feed gas. In this regard, in order to introduce the ROS comprising hydroxyl radicals into the second reactive space 212, a sprayer 220, is employed. The sprayer 220 is equipped with a nozzle that allows the passage of the ROS comprising hydroxyl radicals through it. The purpose of said arrangement is to ensure the ROS, including the hydroxyl radicals, is effectively dispersed and distributed within the second reactive space 212. Furthermore, the second reactive space 212 is equipped with the outlet 212C, which serves the function of releasing or outputting the first treated gas. This outlet 212C enables the controlled extraction of the gas that has undergone the desired reactions within the second reactive space 212, resulting in the production of the first treated gas.

In accordance with an embodiment, the ROS comprising the hydroxyl radicals reacts with the feed gas in the presence of an ultraviolet (UV) light and at least one oxidation catalyst. In this regard, the ROS that includes hydroxyl radicals undergoes a reaction with the feed gas in the presence of ultraviolet (UV) light and at least one oxidation catalyst. This means that when the ROS, containing hydroxyl radicals, comes into contact with the feed gas, a chemical reaction takes place. Said reaction is facilitated by the simultaneous presence of UV light and the at least one oxidation catalyst. The UV light acts as a catalyst, initiating and enhancing the reaction between the ROS comprising hydroxyl radicals and the feed gas. The UV light provides the necessary energy to drive the reaction forward. Additionally, the at least one oxidation catalyst, which is a substance that promotes oxidation reactions, aids in facilitating and accelerating the reaction between the ROS comprising hydroxyl radicals and the feed gas.

In accordance with an embodiment, the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, and a lead oxide.

In accordance with an embodiment, the at least one oxidation catalyst is arranged in a packed-bed reactor. In this regard, by arranging the at least one oxidation catalyst in the packed-bed reactor, several advantages are achieved such as the packed bed provides a large surface area for contact between the gas or reactants and the oxidation catalyst, promoting efficient and effective oxidation reactions. Moreover, the tightly packed configuration also allows for optimal flow distribution and enhanced mass transfer, ensuring thorough interaction between the oxidation catalyst and reactants, such as the ROS comprising hydroxyl radical and the feed gas.

In accordance with an embodiment, the system 200 further comprises a third reactive space 222 that is a reduction reactive space, wherein the third reactive space 222 comprises an inlet 222A configured to receive the first treated gas from the second reactive space 212, a light source and at least one reduction catalyst, wherein a second treated gas is produced by causing the first treated gas to react in presence of the at least one reduction catalyst and UV light generated by the light source, and an outlet 222B configured to output the second treated gas from the third reactive space 222. The third reactive space 222 is designed to facilitate reduction reactions. The third reactive space 222 comprises the inlet 222A that is configured to receive the first treated gas obtained from the second reactive space 212 of the system 200. Additionally, the third reactive space 222 is equipped with a light source and at least one reduction catalyst. When in operation, the third reactive space 222, the first treated gas from the second reactive space 212 is introduced through the inlet 222A. Within the third reactive space 222, the first treated gas is subjected to a reaction process in the presence of the reduction catalyst and UV light generated by the light source. As a result of this reaction, a second treated gas is produced. The specific combination of the reduction catalyst and UV light facilitates the desired reduction reactions. The third reactive space 222 incorporates the outlet 222B, which is configured to release or output the second treated gas. The outlet 222B enables the controlled extraction of the gas that has undergone the reduction reactions within the third reactive space 222, resulting in the production of the second treated gas.

In accordance with an embodiment, the third reactive space 222 is a packed-bed reactor. In this regard, the structure of the third reactive space 222 consists of a packed bed, which is a solid material packed within the packed-bed reactor. The solid material may be in the form of particles, granules, or other configurations. The utilization of a packed-bed reactor in the third reactive space 222 offers several advantages such as providing a large surface area for the desired reduction reactions to occur, promoting efficient contact between the first treated gas and the reduction catalyst. Additionally, the packed bed configuration allows for optimal flow distribution and enhanced mass transfer, ensuring effective interaction between the first treated gas, reduction catalyst, and UV light.

In accordance with an embodiment, the system 200 further comprises at least one pump 224, operatively coupled to the water tank 226, the first reactive space 208, and the oxidization chamber 206, and at least one pump 225, operatively coupled to the first reactive space 208 and the second reactive space 212. The pump 224 is configured to generate nano bubbles or micro bubbles of a mixture of the generated reactive oxygen species and the water before feeding the mixture into the first reactive space 208. While the pump 225 is configured to receive the ROS comprising hydroxyl radicals from the first reactive space 208 and feeding it into the second reactive space 212. The at least one pump 224 is used to generate bubbles of a mixture consisting of the reactive oxygen species (ROS) generated by the system 200 and the water. Specifically, the at least one pump 224 operates by combining the generated ROS and the water, and then generating either nano bubbles or micro bubbles of said mixture. The bubbles, which are extremely small in size, have a high surface area-to-volume ratio and provide enhanced contact between the generated ROS and the water. Moreover, once the at least one pump 224 has successfully generated the bubbles, the mixture is then fed into the first reactive space 208 of the system 200. The first reactive space 208 is the designated location where the interactions and reactions between the generated ROS and the water take place. Moreover, the first reactive space 208 includes a plurality of inlets 208A and 208B configured to receive the feed gas, and the generated reactive oxygen species therein. In an example, the first reactive space 208 includes an outlet 208C to output the first treated gas.

The system 200 is used for gas treatment and purification efficiently with reduced cost and energy consumption. The system 200 is used for producing the first treated gas from the reaction of the feed gas and the reactive oxygen species containing hydroxyl radicals. Therefore, the system 200 is used for reducing hazardous compounds, for example, oxides of nitrogen (NOₓ), and converting the hazardous compounds into stable and less harmful products, such as nitrogen (N₂).

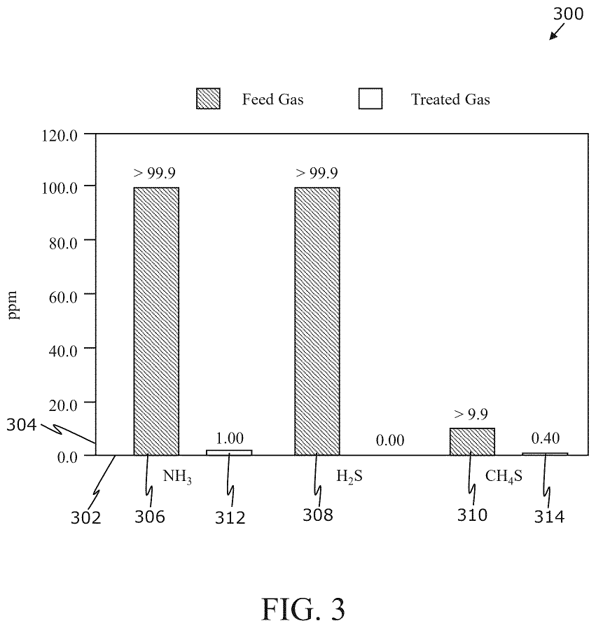

FIG. 3 depicts a graphical representation that illustrates measured values of the concentration of the chemical compounds present in a feed gas and a first treated gas, in accordance with an embodiment of the present disclosure. With reference to FIG. 3, there is shown a graphical representation 300 that includes an X-axis 302, representing chemical compounds present in the feed gas and the first treated gas, and a Y-axis 304, representing the concentration of the chemical compounds present in the feed gas and the first treated gas in ppm (parts per million).

With reference to the graphical representation 300, a first bar 306, a second bar 308, and a third bar 310 illustrate the concentration of the NH₃, the H₂S, and the CH₄S present in the feed gas, respectively. As shown, the first bar 306 depicts that the concentration of the NH₂ in the feed gas is higher than 99.9 ppm (parts per million). Moreover, the second bar 308 depicts that the concentration of the H₂S in the feed gas is higher than 99.9 ppm (parts per million). In addition, the third bar 310 depicts that the concentration of the CH S in the feed gas is higher than 9.9 ppm (parts per million). With reference to the graphical representation 300, a fourth bar 312 and a fifth bar 314 illustrate the concentration of the NH₃ and the CH₄S present in the first treated gas, respectively. As shown, the fourth bar 312 depicts that the concentration of the NH₃ in the first treated gas is reduced to 1.00 ppm (parts per million). The fifth bar 314 depicts that the concentration of the CH₄S in the first treated gas is reduced to 0.4 ppm (parts per million). Beneficially, the first treated gas obtained after the treatment and purification includes zero ppm concentration of the H₂S gas.

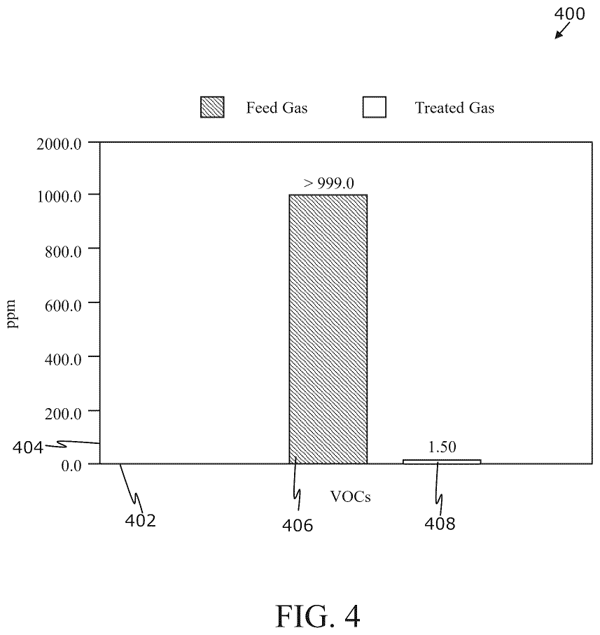

FIG. 4 depicts a graphical representation that illustrates measured values of the concentration of the volatile organic compounds (VOCs) present in a feed gas and a first treated gas, in accordance with an embodiment of the present disclosure. With reference to FIG. 4, there is shown a graphical representation 400 that includes an X-axis 402, representing the VOCs present in the feed gas and the first treated gas, and a Y-axis 404 that illustrates the concentration of the VOCs present in the feed gas and the first treated gas in ppm (parts per million).

With reference to the graphical representation 400, a first bar 406 illustrates the concentration of the VOCs present in the feed gas. As shown, the first bar 406 depicts that the concentration of the VOCs in the feed gas is higher than 999.0 ppm (parts per million). With reference to the graphical representation 400, a second bar 408 illustrates the concentration of the VOCs present in the first treated gas. The second bar 408 depicts that the concentration of the VOCs present in the first treated gas is 1.50 ppm (parts per million).

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A method (100) for gas treatment and purification, comprising:
generating ozone from a supply of gas comprising an oxygen (O₂) gas in presence of a defined voltage;
oxidizing the ozone (O₃), in an oxidization chamber (206), in presence of light of a pre-defined wavelength and at least one oxidation catalyst to generate a reactive oxygen species (ROS);
feeding, in a first reactive space (208), the generated ROS and water from a water tank (226) to generate the ROS comprising hydroxyl radicals; and
supplying, in a second reactive space (212), the ROS comprising the hydroxyl radicals and a feed gas that comprises one or more contaminants to produce a first treated gas, wherein the first treated gas is produced from the reaction of the feed gas with the ROS comprising the hydroxyl radicals.

2. The method (100) according to claim 1, further comprising feeding the generated ROS into a compressor (214) and a diffuser (216) prior to the feeding of the generated ROS into the first reactive space (208), wherein the generated ROS is passed through the compressor and the diffuser in the first reactive space before reacting with the water.

3. The method (100) according to claim 1, further comprising pre-contacting the generated ROS and the water in a mixer prior to the feeding of the generated ROS and the water in the first reactive space (208).

4. The method (100) according to claim 1, further comprising circulating a first portion of the ROS comprising the hydroxyl radicals back to the water tank (226) and supplying a second portion of the ROS comprising the hydroxyl radicals in the second reactive space (212).

5. The method (100) according to claim 1, wherein the first reactive space (208) is a first reactor, and wherein the generated ROS reacts with the water in presence of the light of the pre-defined wavelength and at least one oxidation catalyst.

6. The method (100) according to claim 1, wherein the second reactive space (212) is a second reactor, and wherein the ROS comprising the hydroxyl radicals reacts with the feed gas in presence of the light of the pre-defined wavelength and at least one oxidation catalyst.

7. The method (100) according to claim 1, wherein the first reactive space (208) and the second reactive space (212) are packed-bed reactors.

8. The method (100) according to any one of claim 1, 5, or 6, wherein the light of the pre-defined wavelength is an ultraviolet (UV) light.

9. The method (100) according to any one of the preceding claims, wherein the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, or a lead oxide.

10. The method (100) according to any one of the preceding claims, wherein the at least one oxidation catalyst is arranged in a packed-bed reactor.

11. The method (100) according to claim 1, wherein the ROS is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, or a singlet oxygen.

12. The method (100) according to claim 1, further comprising:
feeding the first treated gas obtained from the second reactive space (212) into a third reactive space (222), wherein the third reactive space is arranged after the second reactive space; and
producing a second treated gas from the third reactive space by causing the first treated gas to react in presence of the ultraviolet (UV) light and at least one reduction catalyst in the third reactive space.

13. The method according to claim 12, wherein the third reactive space is a packed-bed reactor.

14. The method (100) according to claim 1, further comprising feeding a hydrogen peroxide into the first reactive space (208) in order to activate and accelerate the generation of the ROS, wherein the hydrogen peroxide is another ROS.

15. The method (100) according to claim 3 further comprising generating nano bubbles or micro bubbles of a mixture of the generated ROS and the water before feeding the mixture to the first reactive space (208), wherein the generated nano bubbles or micro bubbles increase surface contact between the water and the reactive oxygen species.

16. A system (200) for gas treatment and purification, the system comprising:
a first supply arrangement (202) to provide a supply of gas comprising an oxygen (O₂) gas;
a voltage source (204), operatively coupled to the supply arrangement, to subject a defined voltage to the supply of gas comprising oxygen (O₂) gas to generate ozone (O₃);
an oxidization chamber (206) configured to oxidize the ozone to generate a reactive oxygen species (ROS) in presence of light of a pre-defined wavelength and at least one oxidation catalyst;
a first reactive space (208), operatively coupled to the first supply arrangement and the oxidization chamber, is configured to receive the generated ROS and the water to generate the ROS comprising hydroxyl radicals;
a second supply arrangement (210) to provide a supply of a feed gas that comprises one or more contaminants; and
a second reactive space (212), operatively coupled to the first reactive space and the second supply arrangement, is configured to receive the generated ROS comprising the hydroxyl radicals and produce a first treated gas from the reaction of the feed gas with the ROS comprising the hydroxyl radicals.

17. The system (200) according to claim 16, further comprising a compressor (214) and a diffuser (216) wherein the compressor is operatively coupled to the diffuser and the oxidization chamber (206) and wherein the diffuser is in the first reactive space (208).

18. The system (200) according to claim 16, wherein the light source is an ultraviolet lamp.

19. The system (200) according to claim 16, wherein the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, and a lead oxide.

20. The system (200) according to claim 16, wherein the at least one oxidation catalyst is arranged in a packed-bed reactor.

21. The system (200) according to claim 16, wherein the ROS is at least one of: a superoxide anion, a hydroxyl radical, a hydroxyl ion, a peroxyl radical, an alkoxyl radical, a hydroperoxyl radical, a perhydroxyl radical, a peroxide ion, a hydrogen peroxide, or a singlet oxygen.

22. The system (200) according to claim 16, wherein the oxidization chamber (206) comprises:
an inlet (206A) configured to receive a supply of gas comprising ozone (O₃) into the oxidization chamber;
a light source configured to output the ultraviolet (UV) light of the pre-defined wavelength;
the at least one oxidation catalyst; and
an outlet (206B) configured to output the generated ROS.

23. The system (200) according to claim 16, wherein the first reactive space (208) is a first reactor, the first reactive space comprises:
a light source configured to supply the ultraviolet (UV) light with a uniform distribution of light intensity in the first reactive space;
a catalyst in a packed-bed reactor comprising the at least one oxidation catalyst of one or more transition metal oxides;
a plurality of inlets (208A and 208B) wherein the inlet 208A is configured to receive the hydrogen peroxide (H₂O₂) into the first reactive space and the inlet 208B is configured to receive the generated ROS and the water into the first reactive space; and
an outlet (208C) to output the ROS comprising hydroxyl radicals.

24. The system (200) according to claim 23, wherein the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, and a lead oxide.

25. The system (200) according to claim 16, further comprising a supply of a hydrogen peroxide (218) in into the first reactive space (208) to activate and accelerate the generation of the ROS, wherein the hydrogen peroxide is another ROS.

26. The system (200) according to claim 16, wherein the first reactive space (208) is a packed-bed reactor.

27. The system (200) according to claim 16, wherein the second reactive space (212) is a second reactor, the second reactive space comprises:
a plurality of inlets (212A and 212B) wherein the inlet 212A is configured to receive the generated ROS comprising hydroxyl radicals and the inlet 212B is configured to receive the feed gas therein;
a sprayer (220) comprising a nozzle configured to pass the ROS comprising hydroxyl radicals therethrough; and
an outlet (212C) to output the first treated gas.

28. The system (200) according to claim 27, wherein the ROS comprising the hydroxyl radicals reacts with the feed gas in presence of an ultraviolet (UV) light and at least one oxidation catalyst.

29. The system (200) according to claim 28, wherein the at least one oxidation catalyst is selected from at least one or more transition metal oxides of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, and a lead oxide.

30. The system (200) according to claim 29, wherein the at least one oxidation catalyst is arranged in a packed-bed reactor.

31. The system (200) according to claim 16, further comprising a third reactive space (222) that is a reduction reactive space, wherein the third reactive space comprises:
an inlet (222A) configured to receive the first treated gas from the second reactive space (212);
a light source and at least one reduction catalyst, wherein a second treated gas is produced by causing the first treated gas to react in presence of the at least one reduction catalyst and UV light generated by the light source; and
an outlet (222B) configured to output the second treated gas from the third reactive space.

32. The system (200) according to claim 31, wherein the third reactive space (222) is a packed-bed reactor.

33. The system according to claim 31, wherein the at least one reduction catalyst is selected from at least one of: a zinc oxide, a cadmium oxide, a titanium oxide, a zirconium oxide, a chromium oxide, a tungsten oxide, a manganese oxide, an iron oxide, a ruthenium oxide, a cobalt oxide, a nickel oxide, a palladium oxide, a platinum oxide, a copper oxide, a silver oxide, a vanadium oxide, a tin oxide, a cerium oxide, a silica oxide, an aluminium oxide, a lead oxide, a barium oxide, a lithium oxide, a calcium oxide, a potassium oxide, a magnesium oxide, a sodium oxide.

34. The system (200) according to claim 16, further comprising at least one pump (224), operatively coupled to the water tank (226), the oxidization chamber (206) and the first reactive space (208), and is configured to generate nano bubbles or micro bubbles of a mixture of the generated reactive oxygen species and the water before feeding the mixture into the first reactive space.
